(19) United States
(12) Patent Application Publication
(10) Pub. No.: US 2024/0364721 A1
(43) Pub. Date: Oct. 31, 2024

(54) SYSTEM AND METHOD FOR ISOLATED PROCESS CONTROL NETWORKS TO MONITOR CYBERSECURITY

(71) Applicant: Saudi Arabian Oil Company, Dhahran (SA)

(72) Inventor: Abdullah Y. AlHussain, Al Rashidiya (SA)

(21) Appl. No.: 18/308,077

(22) Filed: Apr. 27, 2023

(51) Int. Cl. H04L 9/40

(52) U.S. Cl. CPC H04L 63/1425; H04L 63/1416

(57) ABSTRACT

A computer-implemented method includes: activating a dual homed server equipped with at least two network interfaces; establishing a first connection to a process control network (PCN) at an industrial plant through a first network interface, wherein the first connection is configured to operate in listening mode alone, and wherein the PCN connects a plurality of field devices operating at the industrial plant; establishing a second connection to a process automation network (PAN) through a second network interface; receiving, at the first one of the at least two network interfaces, a stream of log messages generated by the plurality of field devices operating at the industrial plant; forwarding, using the second one of the at least two network interfaces, the stream of log messages to the PAN; and continuously monitoring, from the PAN, the field devices on the PCN without injecting network traffic into the PCN.

### TECHNICAL FIELD

This disclosure generally relates to cybersecurity monitoring in the context of industrial control and plant automation using a distributed computer network.

### BACKGROUND

A process control network (PCN) is a type of computer network used to monitor and control industrial processes, for example, at an industrial plant. Examples of a PCN can support real-time control and data acquisition in a variety of applications such as manufacturing, energy production, and chemical processing.

### SUMMARY

In one aspect, some implementations provide a computer-implemented method that includes: activating a dual homed server equipped with at least two network interfaces; establishing a first connection to a process control network (PCN) at an industrial plant through a first one of the at least two network interfaces, wherein the first connection is configured to operate in listening mode alone, and wherein the PCN connects a plurality of field devices operating at the industrial plant; establishing a second connection to a process automation network (PAN) through a second one of the at least two network interfaces; receiving, at the first one of the at least two network interfaces, a stream of log messages generated by the plurality of field devices operating at the industrial plant; forwarding, using the second one of the at least two network interfaces, the stream of log messages to the PAN; and continuously monitoring, from the PAN, the field devices on the PCN without injecting network traffic into the PCN.

Implementations may include one or more of the following features.

The computer-implemented method may further include: analyzing, at a Security Information and Event Management (SIEM) server positioned on the PAN, the stream of log messages as the stream is being received such that a real-time map showing an operational status of each field device on the PCN is provided; and determining whether the stream of log messages contains an anomaly. The analyzing may include: identifying patterns in the stream of log messages, wherein the patterns correspond to events that are correlated to one another. The determining may include: based on at least the patterns, detecting one or more deviation from a normal pattern. The determining may include: based on at least the patterns, detecting one or more matches to a known abnormal pattern. The method may further include: in response to determining that the stream of log messages contains an anomaly, updating, on the real-time map, the operational status of a field device associated with the anomaly. The method may further include: in response to determining that the stream of log messages contains no anomaly, continuing said receiving, forwarding, and monitoring.

In another aspect, some implementations provide computer system comprising one or more hardware computer processors configured to perform operations of: activating a dual homed server equipped with at least two network interfaces; establishing a first connection to a process control network (PCN) at an industrial plant through a first one of the at least two network interfaces, wherein the first connection is configured to operate in listening mode alone, and wherein the PCN connects a plurality of field devices operating at the industrial plant; establishing a second connection to a process automation network (PAN) through a second one of the at least two network interfaces, wherein the PCN and the PAN is otherwise not connected; receiving, at the first one of the at least two network interfaces, a stream of log messages generated by the plurality of field devices operating at the industrial plant; forwarding, using the second one of the at least two network interfaces, the stream of log messages to the PAN; and continuously monitoring, from the PAN, the field devices on the PCN without injecting network traffic into the PCN.

Implementations may include one or more of the following features.

The operations may further include: analyzing, at a Security Information and Event Management (SIEM) server positioned on the PAN, the stream of log messages as the stream is being received such that a real-time map showing an operational status of each field device on the PCN is provided; and determining whether the stream of log messages contains an anomaly. The analyzing may include: identifying patterns in the stream of log messages, wherein the patterns correspond to events that are correlated to one another. The determining may include: based on at least the patterns, detecting one or more deviation from a normal pattern. The determining may include: based on at least the patterns, detecting one or more matches to a known abnormal pattern. The operations may further include: in response to determining that the stream of log messages contains an anomaly, updating, on the real-time map, the operational status of a field device associated with the anomaly. The operations may further include: in response to determining that the stream of log messages contains no anomaly, continuing said receiving, forwarding, and monitoring.

In yet another aspect, some implementations provide a non-transitory computer-readable medium comprising software instructions that, when executed, cause a computer processor to perform operations of: activating a dual homed server equipped with at least two network interfaces; establishing a first connection to a process control network (PCN) at an industrial plant through a first one of the at least two network interfaces, wherein the first connection is configured to operate in listening mode alone, and wherein the PCN connects a plurality of field devices operating at the industrial plant; establishing a second connection to a process automation network (PAN) through a second one of the at least two network interfaces, wherein the PCN and the PAN is otherwise not connected; receiving, at the first one of the at least two network interfaces, a stream of log messages generated by the plurality of field devices operating at the industrial plant; forwarding, using the second one of the at least two network interfaces, the stream of log messages to the PAN; and continuously monitoring, from the PAN, the field devices on the PCN without injecting network traffic into the PCN.

Implementations may include one or more of the following features.

The operations may further include: analyzing, at a Security Information and Event Management (SIEM) server positioned on the PAN, the stream of log messages as the stream is being received such that a real-time map showing an operational status of each field device on the PCN is provided; and determining whether the stream of log messages contains an anomaly. The analyzing may include: identifying patterns in the stream of log messages, wherein the patterns correspond to events that are correlated to one another. The determining may include: based on at least the patterns, detecting one or more deviation from a normal pattern. The determining may include: based on at least the patterns, detecting one or more matches to a known abnormal pattern. The operations may further include: in response to determining that the stream of log messages contains an anomaly, updating, on the real-time map, the operational status of a field device associated with the anomaly. The operations may further include: in response to determining that the stream of log messages contains no anomaly, continuing said receiving, forwarding, and monitoring

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 is a diagram illustrating an example of a configuration according to some implementations of the present disclosure.

FIG. 2 illustrates additional details of the example of the configuration used in some implementations of the present disclosure.

FIG. 3 is a flow chart illustrating an example according to some implementations of the present disclosure.

FIG. 4 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The disclosed technology is directed to system and technology to improve cybersecurity monitoring (e.g., extended visibility of the network and enhanced ability of continuous monitoring). In an industrial plant, process control networks (PCNs) can be designed to support real-time control and data acquisition in a variety of applications such as manufacturing, energy production, and chemical processing By way of examples, a PCN can include a variety of hardware and software components, including sensors, programmable logic controllers (PLCs), supervisory control and data acquisition (SCADA) systems, and other industrial control systems. These components are connected using wired or wireless communication technologies to enable data exchange and control of the industrial process. By design, the PCNs are isolated from information layer network, e.g., a process automation network (PAN). Examples of PAN can be designed to automate the operation of a production line with a human-machine interface (HMI). The isolation of the PCN from the PAN can limit cybersecurity visibility into the network events at the PCN level while also hindering the ability of continuous cybersecurity monitoring by, for example, a security operations center (SOC).

Some implementations incorporate a dual homed server, which can be equipped with two network interface cards (NIC). In some cases, one NIC is connected to the PAN and the other is connected to the PCN. The dual homed server listens to syslog messages coming from devices on the PCN network and forwards these security events to a security information and events monitoring (SIEM) server that resides on the PAN. Between the PCN and the dual homed server, communication is one-way, i.e., from the PCN to the dual homed server only such that the dual homed server is a passive listener without injecting packets into the PCN network. In other words, devices on the PCN network are not disturbed and would not even see network packets originating from outside the PCN network. By keeping the PCN network in isolation, the implementations can help preventing potential malfunction of the proprietary protocols spilling over the PCN network. At the same time, however, the operational status of the devices on the PCN network are accessible to the SIEM server for continuous monitoring. In this manner, implementations can achieve visibility into the PCN network, along with continuous monitoring, regardless of the vendor-specific technology used in PCN, which can be proprietary. Because devices on the PCN can operate proprietary protocols, the PCN network can be sensitive to connectivity to other systems for security functions that include security events monitoring and cybersecurity monitoring.

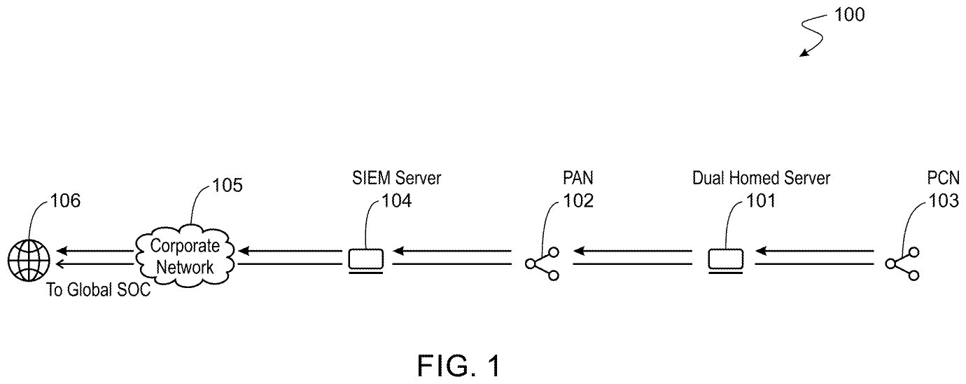

As illustrated in diagram 100 of FIG. 1, implementations can incorporate a dual homed server 101 connected to PAN 102 and PCN 103. The PCN 103 can be designed to monitor and control industrial processes in real-time. For controlling industrial processes, PCN 103 can host field devices, which can include, for example, valves, valve positioners, switches and transmitters (e.g., temperature, pressure, level and flow rate sensors). These field devices are located within the process environment and generally perform physical process control functions such as opening or closing valves, measuring process and/or environmental variables including, for example, flow, temperature, and pressure within the process plant or system. Smart field devices may also perform control calculations, alarming functions, and other control functions commonly implemented within the controller.

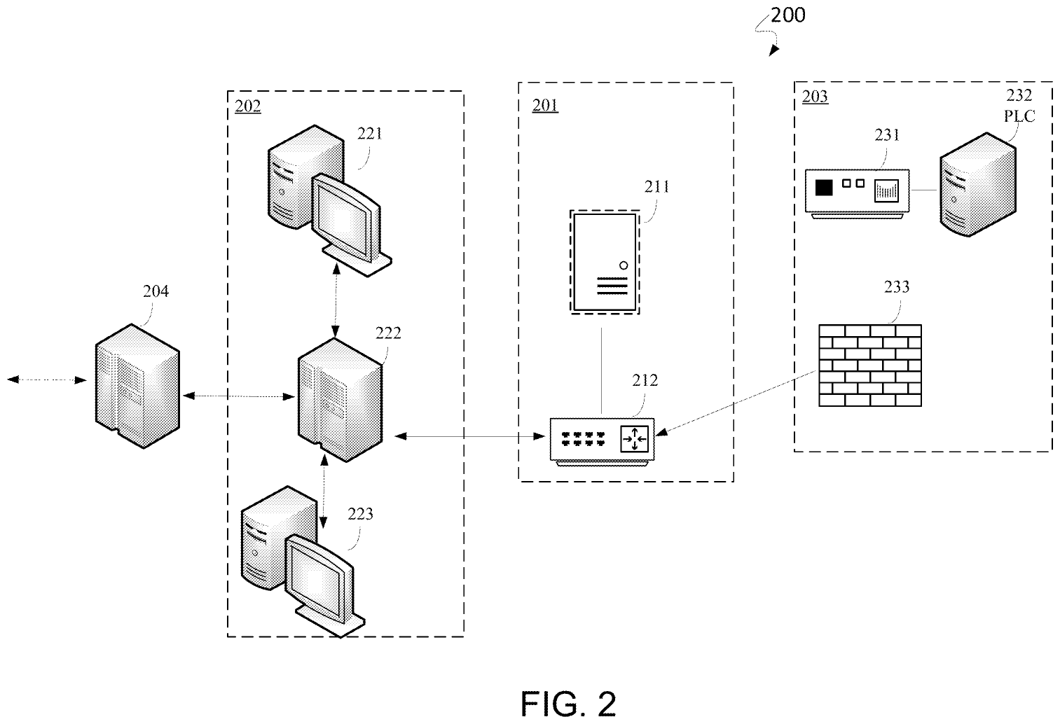

PCN 103 may also include controller devices such as, for example, programmable logic controllers (PLCs), supervisory control and data acquisition (SCADA) systems, and other industrial control systems. Further referring to diagram 200 of FIG. 2, an example of PCN 203 can include PLC 232, field device 231 and firewall 233. As illustrated, controller devices (e.g., PLC 232) may be communicatively coupled to the field devices (e.g., field device 231) via physical layers which can be analog, digital or combined analog/digital buses, and can include one or more wireless communication links or networks. In the example shown in FIG. 2, PCN 203 includes firewall 233 to isolate the PCN 203 from the rest of the network. The control devices, which are also typically located within the plant environment, can receive signals indicative of process measurements from the field devices and other information pertaining to the field devices. Based on the measurements, the control devices can execute, e.g., a control application to make process control decisions, generate process control signals, and coordinate with the control modules or blocks being performed in the field devices, such as HART®, WirelessHART®, and FOUNDATION® Fieldbus field devices.

In some cases, the controller devices can send control signals to various input/output (I/O)) devices, which, in turn, can then send these control signals over specialized communication lines or links (communication physical layers) to the field devices to thereby control the operation of at least a portion of the process plant or system, e.g., to control at least a portion of one or more industrial processes running or executing within the plant or system. The I/O devices, which are also typically located within the plant environment, are generally disposed between a process controller and one or more field devices, and enable communications therebetween, e.g., by converting electrical signals into digital values and vice versa. A variety of I/O devices are provided to support field devices that use specialized communication protocols. More particularly, a distinct I/O device can be provided between a process controller and each of the field devices that uses a particular communication protocol, such that a first I/O device is used to support HART field devices, a second I/O device is used to support Fieldbus field devices, a third I/O device is used to support Profibus field devices, etc. In some cases, field devices, controllers, and I/O devices are generally referred to as “process control devices,” and are generally located, disposed, or installed in a field environment of a process control system or plant.

PAN 102, on the other hand, is designed to automate manual tasks and to provide human-machine interface that allows an operator to have access to the measurement data (e.g., to visualize measurements of on-going processes). While PCN 103 is focused on real-time monitoring and control of industrial processes, PAN 102 is focused on automating manual tasks to achieve higher levels of efficiency and consistency. Compared with PCN 103, PAN 102 can place greater emphasis on automating manual tasks used to be performed by human operators. As illustrated in FIG. 2, PAN 102 may include gateway server 222 to bridge communication with the rest of the network. PAN 102 may further include workstation computers 221 and 223 programmed for automating controlling operations. For example, gateway server 222 may receive control signals from controller devices and measurement data from field devices on PCN 103. The control signals and measurement data may be forwarded to workstation computers 221 and 222 for visualization or automated control operations. In some cases, workstation computers 221 and 222 can provide human-machine interface (HMI) for an operator to visualize the on-going processes, and provide input. By design, PAN 102 and PCN 103 are disconnected. In the implementations, however, PAN 102 is connected to control system workstations and, through dual homed server 101, to PCN 103. Notably, the implementations impose a one-way network traffic from PCN 103 to dual homed server 101, and not the other way around. Moreover, the implementations can centralize the dual homed configurations so that dual homed server 101, which becomes more at security risk by virtue of connecting two otherwise segregated networks, can be fortified and monitored without having to duplicate the security measures repeatedly. Compared to distributing the dual homed configurations to each computing device on PCN 103, the dual homed server 103 can lead to more streamlined and efficient measures to enforce network security.

By design, PCNs are generally isolated from information layer network (e.g., PAN). Such isolation can limit the cybersecurity visibility of the network and limit the ability of continuous cybersecurity monitoring by a security operations center (SOC).

Implementations, however, introduces dual homed server 101, which can listen to syslog messages coming from devices on the PCN 103 and forward these security events to a security information and events monitoring (SIEM) server 104 that resides on the PAN 102. SIEM server 104 further communicates with corporate network 105 (e.g., an enterprise network), which may further communicate with a global security operations center 106. In this manner, the security monitoring of field devices on PCN 103 can be performed continuously and in real-time without disturbing the operation of the field devices which could run on proprietary protocols sensitive outside connectivity.

An example of a dual homed server 201 is shown in FIG. 2. Dual homed server 201 may include a controller device 211 that controls a switching device 212. The switching device 212 may include multiple network interface cards. One network interface card may listen to syslog messages coming from devices on the PCN 203. Here, firewall 233 on PCN 203 may allow one-way network traffic so that syslog messages from field devices on PCN 203 can reach the network interface card on switching device 212. Another network interface card on switching device 212 can forward the packets carrying the syslog messages to PAN 202. PAN 202 further communicates with SIEM server 204, which may further communicate with an enterprise network.

By way of illustration, SIEM server 204 may aggregate data from multiple sources, e.g., multiple field devices on PCN 203 (or multiple instances of PCN 203). The data being aggregated can be in the form of a stream of data packages carrying, e.g., log messages from field devices. SIEM server 204 may analyze the aggregated data for patterns that can correspond to events on PCN 203. In some cases, the operational status of each field device on PCN 203 can be mapped in real-time to facilitate continuous monitoring. SIEM server 204 may determine whether the aggregated data contain an anomaly. In some cases, SIEM server 204 may identify deviations from the norm, or matches to a known abnormal pattern. Once the anomaly is detected, SIEM server 204 may update, on the real-time map, the operational status of a field device associated with the anomaly. SIEM server 204 may also take appropriate action by for example, generate an alert using audio or video means and instruct other security controls to stop an activity's progress. When no anomaly is detected, SIEM server 204 may continue the monitoring operation. During the monitoring process, SIEM server 204 may aggregate security event logs from network devices.

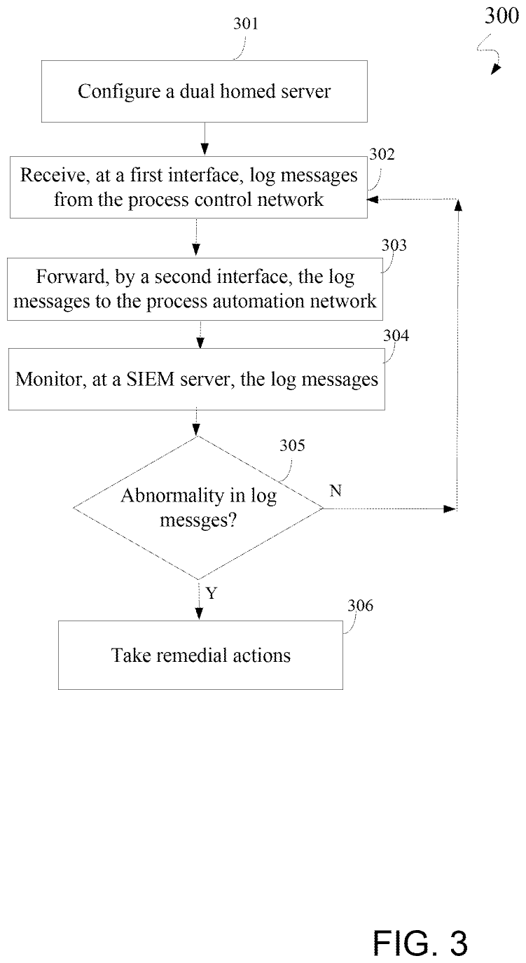

FIG. 3 is a flow chart 300 illustrating an example of a process according to some implementations of the present disclosure. The process may initiate with configuring a dual homed server between a process control network (PCN) and a process automation network (PAN) (301). The dual home server may be equipped with multiple interfaces (or ports). For example, a first interface can be connected with the PCN while a second (distinct from the first) interface is connected to the PAN. The PCN may host a variety of field devices and use proprietary protocols. The PCN may thus be sensitive to connectivity with other systems for security functions such as security event monitoring and cybersecurity monitoring.

The process may then operate the dual home server to implement continuous monitoring of the PCN. For example, the dual homed server may receive, at a first network interface, log messages (e.g., syslog messages) originating from field devices on PCN (302). By way of operation, the field devices may generate log messages that indicate the status and health of each field device. These log messages may be filtered by a firewall of the PCN to reach the first network interface, which operates only in a listening mode and without injecting packets or sending acknowledgements. The dual homed server may forward, at a second network interface (distinct from the first network interface), packets carrying the event messages to the PAN (303). The packet forwarding operation may not masquerading the source location of the forwarded packets.

The process may then monitor (e.g., at a SIEM server on the PAN) the log messages (304). The monitoring is continuous and non-stop. The monitoring may reveal statistical behavior of the field devices on the PCN. The process may determine whether the log messages indicate abnormality on the PCN (305). In response to determining no abnormality, the process may continue receiving, forwarding, and monitoring operations. In response to determining one or more field devices exhibit abnormality, the process may proceed to take remedial actions (306). For example, the process may raise a red flag on a console where a map of the field devices is shown to an operator. The process may also alert the operator in other means using audio and video feedback.

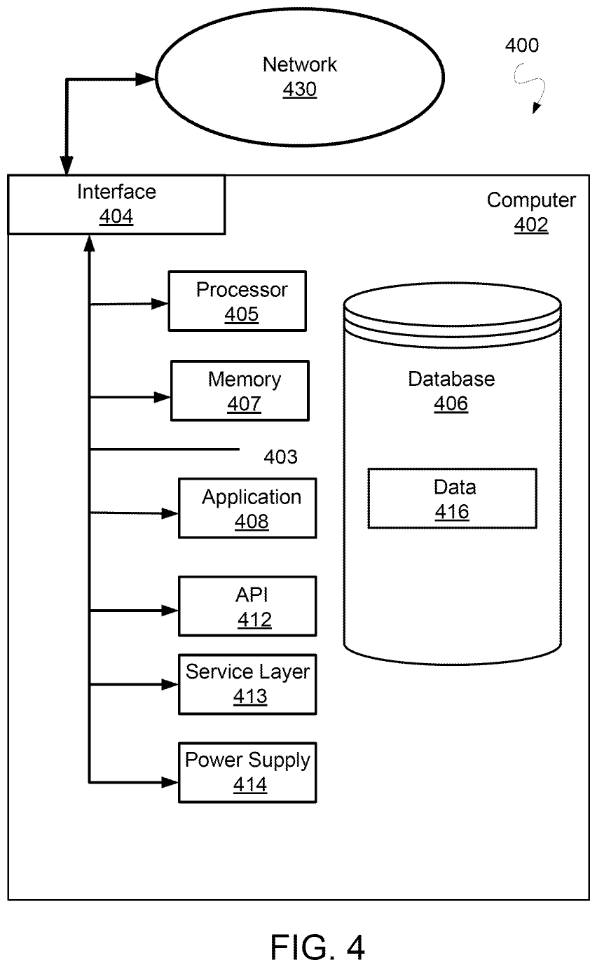

FIG. 4 is a block diagram 400 illustrating an example of a computer system 400 used to provide computational functionalities associated with described algorithms, methods, functions, processes, flows, and procedures, according to an implementation of the present disclosure. The illustrated computer 402 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 402 can comprise a computing device that includes an input device, such as a keypad, keyboard, touch screen, another input device, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a computer system as a client, network component, a server, a database or another persistency, another role, or a combination of roles for performing the subject matter described in the present disclosure. The illustrated computer 402 is communicably coupled with a network 430. In some implementations, one or more components of the computer 402 can be configured to operate within an environment, including cloud-computing-based, local, global, another environment, or a combination of environments.

The computer 402 is an electronic computing device operable to receive, transmit, process, store, or manage data and information associated with the described subject matter. According to some implementations, the computer 402 can also include or be communicably coupled with a server, including an application server, e-mail server, web server, caching server, streaming data server, another server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users, external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using this service layer. Software services, such as those provided by the service layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and comprises logic encoded in software, hardware, or a combination of software and hardware. More specifically, the interface 404 can comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory, conventional, or another type of database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. As illustrated, the database 406 holds data 416 including, for example, data from service call log 201, mapping table 202, staging table 203, as explained in more detail in association with FIGS. 1-3.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power-supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware-or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/-R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer.

Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperable coupled with a hardware processor configured to perform the computer-implemented method or the instructions stored on the non-transitory, computer-readable medium.

What is claimed is:

1. A computer-implemented method comprising:
activating a dual homed server equipped with at least two network interfaces;
establishing a first connection to a process control network (PCN) at an industrial plant through a first one of the at least two network interfaces, wherein the first connection is configured to operate in listening mode alone, and wherein the PCN connects a plurality of field devices operating at the industrial plant;
establishing a second connection to a process automation network (PAN) through a second one of the at least two network interfaces;
receiving, at the first one of the at least two network interfaces, a stream of log messages generated by the plurality of field devices operating at the industrial plant;
forwarding, using the second one of the at least two network interfaces, the stream of log messages to the PAN; and
continuously monitoring, from the PAN, the field devices on the PCN without injecting network traffic into the PCN.

2. The computer-implemented method of claim 1, further comprising:
analyzing, at a Security Information and Event Management (SIEM) server positioned on the PAN, the stream of log messages as the stream is being received such that a real-time map showing an operational status of each field device on the PCN is provided; and
determining whether the stream of log messages contains an anomaly.

3. The computer-implemented method of claim 2, wherein said analyzing comprises:
identifying patterns in the stream of log messages, wherein the patterns correspond to events that are correlated to one another.

4. The computer-implemented method of claim 3, wherein said determining comprises:
based on at least the patterns, detecting one or more deviation from a normal pattern.

5. The computer-implemented method of claim 3, wherein said determining comprises:
based on at least the patterns, detecting one or more matches to a known abnormal pattern.

6. The computer-implemented method of claim 2, further comprising:
in response to determining that the stream of log messages contains an anomaly, updating, on the real-time map, the operational status of a field device associated with the anomaly.

7. The computer-implemented method of claim 2, further comprising:
in response to determining that the stream of log messages contains no anomaly, continuing said receiving, forwarding, and monitoring.

8. A computer system comprising one or more hardware computer processors configured to perform operations of:
activating a dual homed server equipped with at least two network interfaces;
establishing a first connection to a process control network (PCN) at an industrial plant through a first one of the at least two network interfaces, wherein the first connection is configured to operate in listening mode alone, and wherein the PCN connects a plurality of field devices operating at the industrial plant;
establishing a second connection to a process automation network (PAN) through a second one of the at least two network interfaces, wherein the PCN and the PAN is otherwise not connected;
receiving, at the first one of the at least two network interfaces, a stream of log messages generated by the plurality of field devices operating at the industrial plant;
forwarding, using the second one of the at least two network interfaces, the stream of log messages to the PAN; and
continuously monitoring, from the PAN, the field devices on the PCN without injecting network traffic into the PCN.

9. The computer system of claim 8, wherein the operations further comprise:
analyzing the stream of log messages as the stream is being received such that a real-time map showing an operational status of each field device on the PCN is provided; and
determining whether the stream of log messages contains an anomaly.

10. The computer system of claim 9, wherein said analyzing comprises:
identifying patterns in the stream of log messages, wherein the patterns correspond to events that are correlated to one another.

11. The computer system of claim 10, wherein said determining comprises:
based on at least the patterns, detecting one or more deviation from a normal pattern.

12. The computer system of claim 10, wherein said determining comprises:
based on at least the patterns, detecting one or more matches to a known abnormal pattern.

13. The computer system of claim 9, wherein the operations further comprise:
in response to determining that the stream of log messages contains an anomaly, updating, on the map, the operational status of a field device associated with the anomaly.

14. The computer system of claim 9, wherein the operations further comprise:
in response to determining that the stream of log messages contains no anomaly, continuing said receiving, forwarding, and monitoring.

15. A non-transitory computer-readable medium comprising software instructions that, when executed, cause a computer processor to perform operations of:
activating a dual homed server equipped with at least two network interfaces;
establishing a first connection to a process control network (PCN) at an industrial plant through a first one of the at least two network interfaces, wherein the first connection is configured to operate in listening mode alone, and wherein the PCN connects a plurality of field devices operating at the industrial plant;
establishing a second connection to a process automation network (PAN) through a second one of the at least two network interfaces, wherein the PCN and the PAN is otherwise not connected;
receiving, at the first one of the at least two network interfaces, a stream of log messages generated by the plurality of field devices operating at the industrial plant;
forwarding, using the second one of the at least two network interfaces, the stream of log messages to the PAN; and
continuously monitoring, from the PAN, the field devices on the PCN without injecting network traffic into the PCN.

16. The non-transitory computer-readable medium of claim 15, wherein the operations further comprise:
analyzing the stream of log messages as the stream is being received such that a real-time map showing an operational status of each field device on the PCN is provided; and
determining whether the stream of log messages contains an anomaly.

17. The non-transitory computer-readable medium of claim 16, wherein said analyzing comprises:
identifying patterns in the stream of log messages, wherein the patterns correspond to events that are correlated to one another.

18. The non-transitory computer-readable medium of claim 17, wherein said determining comprises:
based on at least the patterns, detecting one or more deviation from a normal pattern.

19. The non-transitory computer-readable medium claim 17, wherein said determining comprises:
based on at least the patterns, detecting one or more matches to a known abnormal pattern.

20. The non-transitory computer-readable medium of claim 16, wherein the operations further comprise:
in response to determining that the stream of log messages contains an anomaly, updating, on the map, the operational status of a field device associated with the anomaly.
